(19) United States
(12) Patent Application Publication
(10) Pub. No.: US 2015/0235349 A1
(43) Pub. Date: Aug. 20, 2015

(54) IMAGE PROCESSING APPARATUS, IMAGE PROCESSING METHOD, AND COMPUTER-READABLE RECORDING MEDIUM

(71) Applicants: Hiroyuki MORITA, Kanagawa (JP); Keiichi IWASAKI, Kanagawa (JP)

(72) Inventors: Hiroyuki MORITA, Kanagawa (JP); Keiichi IWASAKI, Kanagawa (JP)

(73) Assignee: Ricoh Company, Ltd., Tokyo (JP)

(21) Appl. No.: 14/560,042

(22) Filed: Dec. 4, 2014

(30) Foreign Application Priority Data
Feb. 19, 2014 (JP) 2014-029698

(51) Int. Cl. G06T 5/00; H04N 5/232

(52) U.S. Cl. CPC G06T 5/001; H04N 5/23238; G06T 2207/10004; G06T 2207/20021

(57) ABSTRACT

An image processing apparatus includes a scanning unit which scans a reference image data generated by dividing an input image data having distortion into plural areas, a storage which stores the scanned image data, a processing range determining unit which determines a range for the image data to be processed among the stored image data, and a correcting unit which performs a distortion correction on the image data within the determined range. The processing range determining unit determines the range to be larger than the reference image data.

### CROSS-REFERENCE TO RELATED APPLICATIONS

The present application is based on and claims priority from Japanese Patent Application Number 2014-029698, filed Feb. 19, 2014, the disclosure of which is hereby incorporated by reference herein in its entirety.

### BACKGROUND

The present invention relates to an image processing apparatus, an image processing method and a computer-readable recording medium, especially those which configured to perform a predetermined image deformation processing to an input image data and to output the processed data as an output data.

It is preferable to have a wide field angle for an imaging apparatus, such as a TV conference system and a monitoring camera. To acquire an image with a wide angle view, a wide field angle lens, for instance a fisheye lens, is normally used.

Since a wide filed angle lens has distortion-aberration characteristics and distortion rates increase as closing to the edge of the lens, it is required to perform image processing in order to correct the image distortion. In a conventional technique, it is configured to use coordinate value and sub-pixel value of a pixel of an input image as deformation parameters and to perform an interpolation calculation processing (e.g., a bilinear interpolation or a bi-cubic interpolation) for each pixel of the output image, so as to form pixels of the output image.

Generally, an image processing apparatus partially stores the input image data into an internal storage circuit and performs the image processing to the stored image data. Normally, the capacity of the internal storage circuit is determined beforehand as designing the apparatus. Hence, it is preferable to use the (limited) capacity efficiently and optimally when performing the image processing.

A Patent Document 1 (Japanese Laid-Open Patent Application No. 2013-110647) teaches to compress an image data before storing the image data into an internal storage circuit, and to perform the image processing to correct the optical distortion of the image taken in a zoom mode.

### SUMMARY

There is another known technique to correct the optical distortion, which is configured to divide the input image data into plural areas, to acquire distortion rates of the input image data to store into an internal storage circuit, and to perform a deformation processing for each divided area of the input image using the stored distortion rates.

In this known technique, since the input image data is divided into areas in accordance with a size of an area of the output image data, the size of each area in the output image data becomes the same, while the size of each area in the input image data differs. Further, since the capacity of the internal storage circuit is determined beforehand depending on the area with the largest capacity as designing the apparatus, it wastes the capacity of the internal storage circuit for some of the areas.

Also, it needs to store the image data into the internal storage circuit and to perform the distortion correction processing using parameters and/or image data stored in an external storage circuit repeatedly for each area. In other words, it needs to access to the external storage circuit frequently, so that it decreases the efficiency of the image processing.

Although Patent Document 1 discloses a technique to correct the optical distortion of image data with limited capacity, it does not teach a technique to correct the optical distortion by dividing the input image data into areas.

An object of the embodiments of this invention is, therefore, to provide an image processing apparatus which enables correction of the optical distortion efficiently even if a capacity of an internal storage circuit is limited.

In order to achieve the above object, an embodiment of the present invention provides an image processing apparatus comprising a scanning unit which scans a reference image data generated by dividing an input image data having distortion into plural areas, a storage which stores the scanned image data, a processing range determining unit which determines a range for the image data to be processed among the stored image data, and a correcting unit which performs a distortion correction on the image data within the determined range, wherein the processing range determining unit determines the range to be larger than the reference image data.

### BRIEF DESCRIPTION OF THE DRAWINGS

FIG. 1 is a flowchart showing operation performed by an image processing apparatus according to Embodiment 1 of the present invention;

FIG. 2 is a block diagram showing a configuration of the image processing apparatus according to Embodiment 1 of the present invention;

FIG. 3 is a block diagram showing another configuration of the image processing apparatus according to Embodiment 1 of the present invention;

FIG. 4 is a diagram showing an input image data according to Embodiment 1 of the present invention;

FIG. 5 is a diagram showing an output image data according to Embodiment 1 of the present invention;

FIG. 6 is a diagram showing an input image data according to Embodiment 1 of the present invention;

FIG. 7 is a diagram showing an input image data according to Embodiment 1 of the present invention; and

FIG. 8 is a flowchart showing operation performed by a conventional image processing apparatus.

### DETAILED DESCRIPTION OF THE PREFERRED EMBODIMENTS

Hereinafter, an image processing apparatus according to embodiments of the present invention will be explained with reference to the drawings.

### Embodiment 1

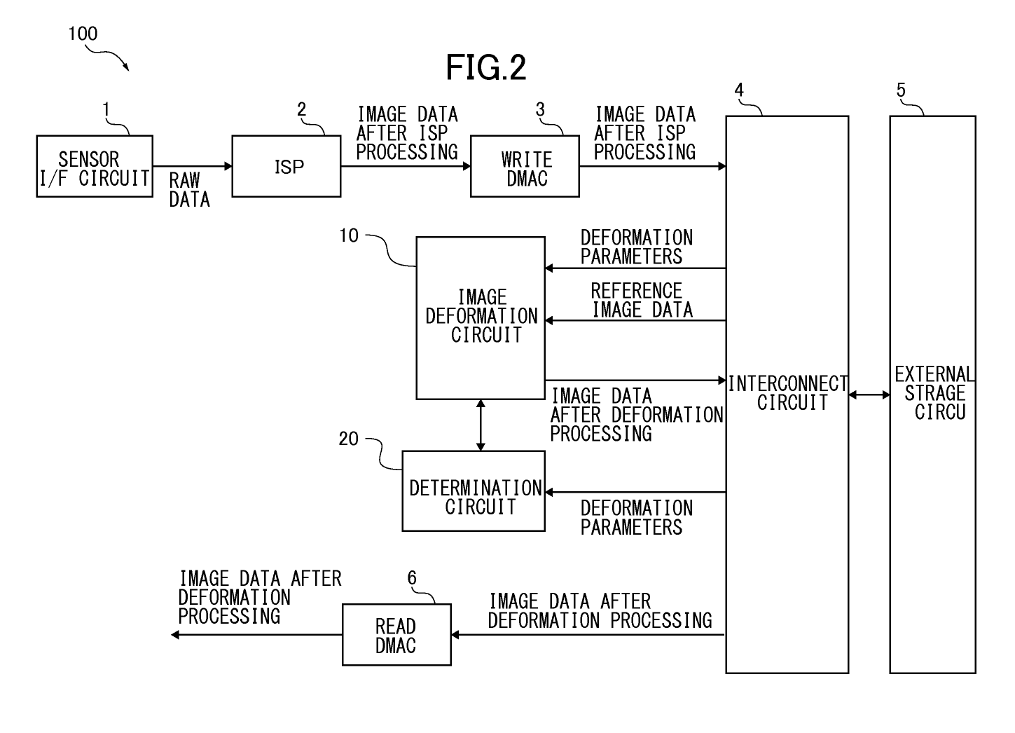

FIG. 2 is a block diagram showing a configuration of an image processing apparatus 100 according to Embodiment 1. As illustrated, the image processing apparatus 100 includes a sensor interface circuit (shown as “sensor I/F circuit”) 1, an image signal processor (ISP) 2, a write direct memory access controller (write DMAC) 3, an interconnect circuit 4, an external storage circuit 5, a read DMAC 6, an image deformation circuit 10, and a determination circuit 20.

The sensor interface circuit 1 receives an input image data from a CCD sensor, such as a camera, deforms the received input image data into a RAW data, which is a predetermined input image data, and outputs the deformed RAW data to the ISP 2.

The ISP 2 performs a preset image processing to the RAW data (e.g., dividing the RAW data into areas) and outputs (stores) the processed image data into the external storage circuit 5 via the write DMAC 3 and interconnect circuit 4. Note that the RAW data divided into plural areas is hereinafter called “reference image data”. The preset image processing performed by the ISP 2 also includes other processing performed for each pixel, such as correction of the optical system (e.g., a lens) and correction of flaw caused by variation of the image sensor, etc.

The write DMAC 3 is a circuit to write the image data processed by the ISP 2 into the external storage circuit 5 temporally. The interconnect circuit 4 works as an arbitrating circuit for other circuits connected to the external storage circuit 5, and is connected with the external storage circuit 5, the image deformation circuit 10, and the read DMAC 6.

The image deformation circuit 10, which represents a distortion correcting unit, performs a prescribed image deformation processing, for example distortion correction processing, to the reference image data based on deformation parameters and the reference image data retrieved from the external storage circuit 5 via the interconnect circuit 4. The image deformation circuit 10, then outputs (stores) the deformed (corrected) image data to the external storage circuit 5 via the interconnect circuit 4. The read DMAC 6 reads out the deformed image data from the external storage circuit 5 via the interconnect circuit 4 and outputs to an image displaying device (not shown).

As mentioned above, the image processing apparatus 100 is configured such that the image data after the ISP processing, the deformed image data, and the deformation parameters used for the prescribed image deformation processing are stored in the external storage circuit 5.

The image data after the ISP processing is updated for each frame in response to the input image data acquired by the CCD sensor. The deformed image data is also updated for each frame. The deformation parameters used for the prescribed image deformation processing are updated when needed. Note that when the same deformation processing is performed, it does not have to update the deformation parameters.

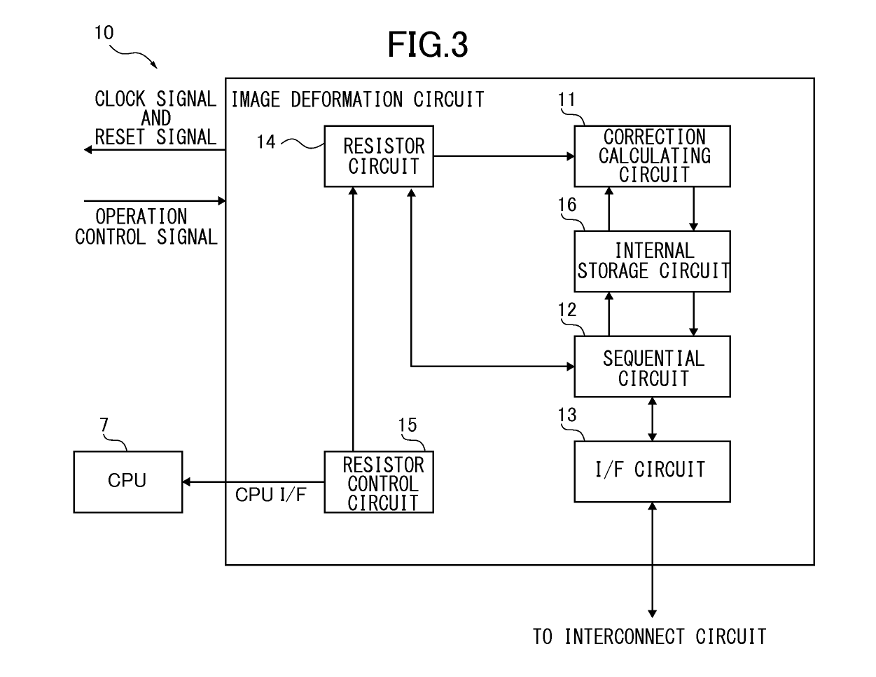

FIG. 3 is a block diagram showing the configuration of the image deformation circuit 10 shown in FIG. 2. As illustrated, the image deformation circuit 10 includes a correction calculating circuit 11, an internal storage circuit 16, a sequential circuit 12, an interface circuit (shown as “I/F circuit” in FIG. 3) 13, a resistor circuit 14, and a resistor control circuit 15.

The interface circuit 13 is connected to the external storage circuit 5 through the interconnect circuit 4, and exchanges the deformation parameters, the reference image data, and the deformed (corrected) image data with the external storage circuit 5.

Specifically, the interface circuit 13 retrieves the deformation parameters and reference image data from the external storage circuit 5 via the interconnect circuit 4 and inputs them to the sequential circuit 12, while outputs (stores) the deformed image data to the external storage circuit 5.

The resistor control circuit 15 controls read and write processing of the resistor circuit 14, which is used for the correction calculating circuit 11 and sequential circuit 12, based on the control signal sent from a CPU 7. The sequential circuit 12 controls the overall operation of the image deformation circuit 10.

It should be noted that the image deformation circuit 10 is also supplied with clock signals, reset signals, and operation control signals from an external circuit. The correction calculating circuit 11 retrieves the deformation parameters and reference image data from the internal storage circuit 16 and forms (generates) an output image. Here, the correction calculating circuit 11, etc. represent a scanning unit which scans the reference image data.

The operation and distortion correction processing of the determination circuit 20 shown in FIG. 2 will now be explained. As illustrated in FIG. 5, the output image data is divided into areas, and the image deformation circuit 10 corrects the distortion of the image data for each area to generate the corrected output image data correspondingly.

Here, the determination circuit 20 (a processing range determination unit) has information regarding a storage capacity of the internal storage circuit 16 (a storage) installed inside the image deformation circuit 10, and the determination circuit 20 determines whether the reference image data for plural areas can be scanned based on the retrieved deformation parameters.

For each area, the generated output image data is stored into the external storage circuit 5 via the interconnect circuit 4. When the processing is finished for all areas of the reference image data, the output image data stored in the external storage circuit 5 is outputted via the interconnect circuit 4 and read DMAC 6.

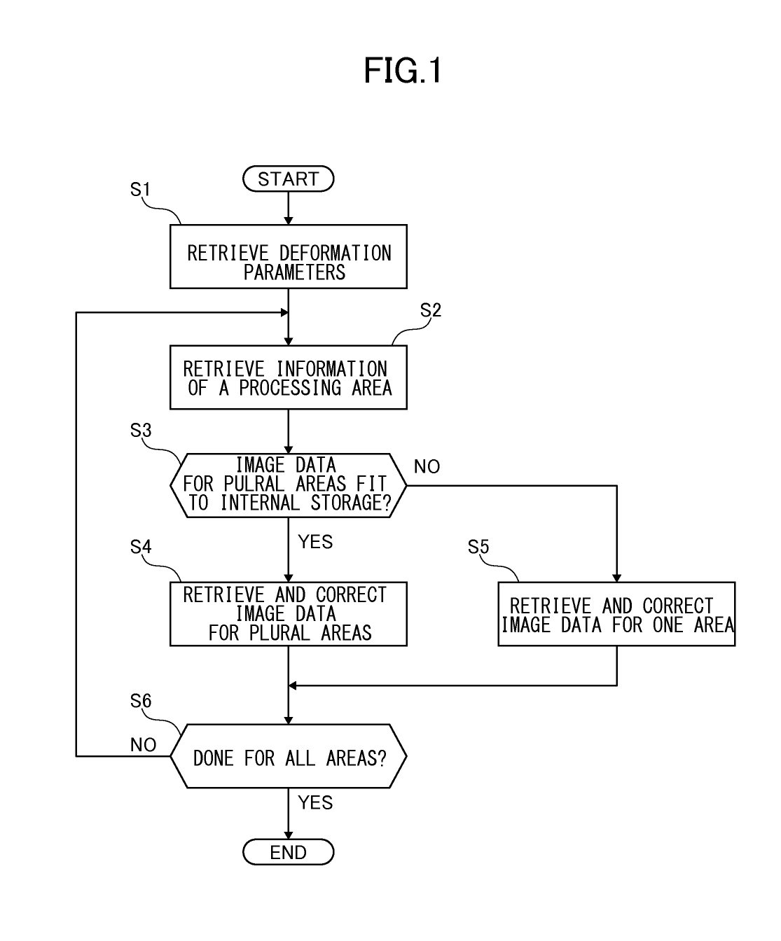

The detailed operation performed by the determination circuit 20 will be explained with reference to FIG. 1. First, it retrieves the deformation parameters stored in the external storage circuit 5 (step S1). Next, it retrieves information of the area of the reference image data on which the image deformation circuit 10 is going to perform the processing in the next steps (step S2).

The determination circuit 20 determines whether the reference image data for the next processing fits into the capacity of the internal storage circuit 16 based on the deformation parameters (which are generated in accordance with the distortion of the input image data) and the information about in which area the image deformation circuit 10 is currently processing (step S3). In other word, it is determined whether the reference image data for plural areas (the current data and the next data) can be stored in the internal storage circuit 16.

When it is determined that the reference image data for plural areas can be stored into the internal storage circuit 16 (S3: YES), it determines how many areas are stored into the internal storage circuit 16, and retrieves information necessary for the next processing from the external storage circuit 5. When it is determined that the reference image data for only one area can be stored into the internal storage circuit 16 (S3: NO), it determines to store the reference image data for one area into the internal storage circuit 16, and retrieves information necessary for the next processing from the external storage circuit 5.

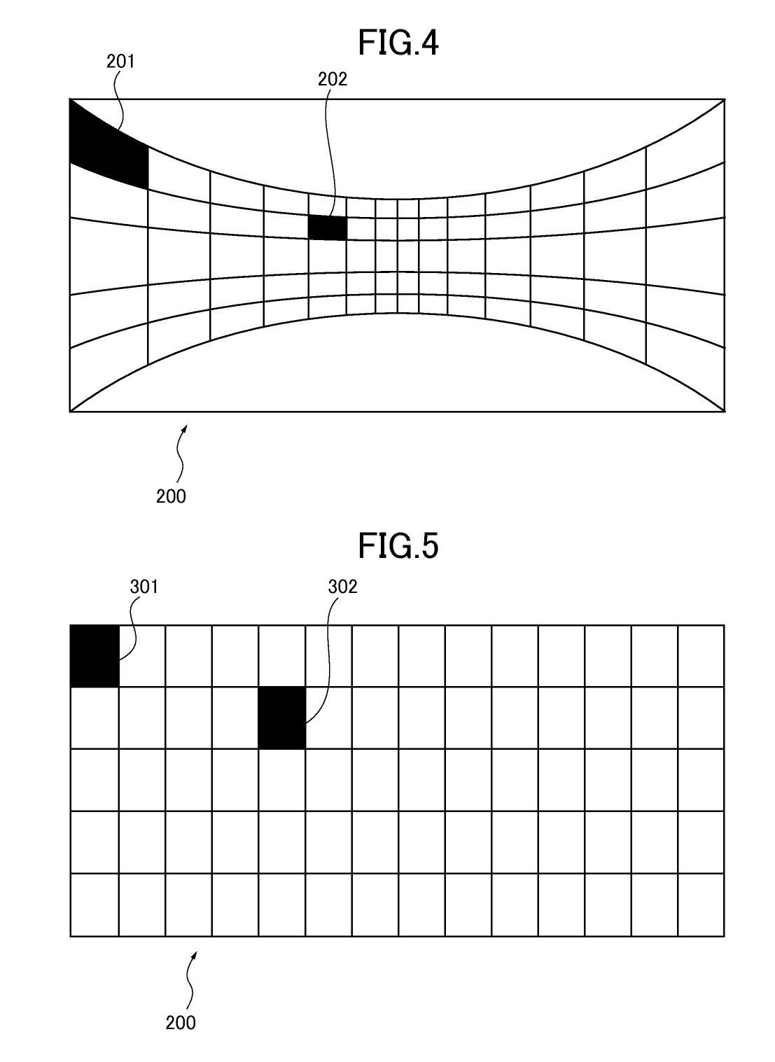

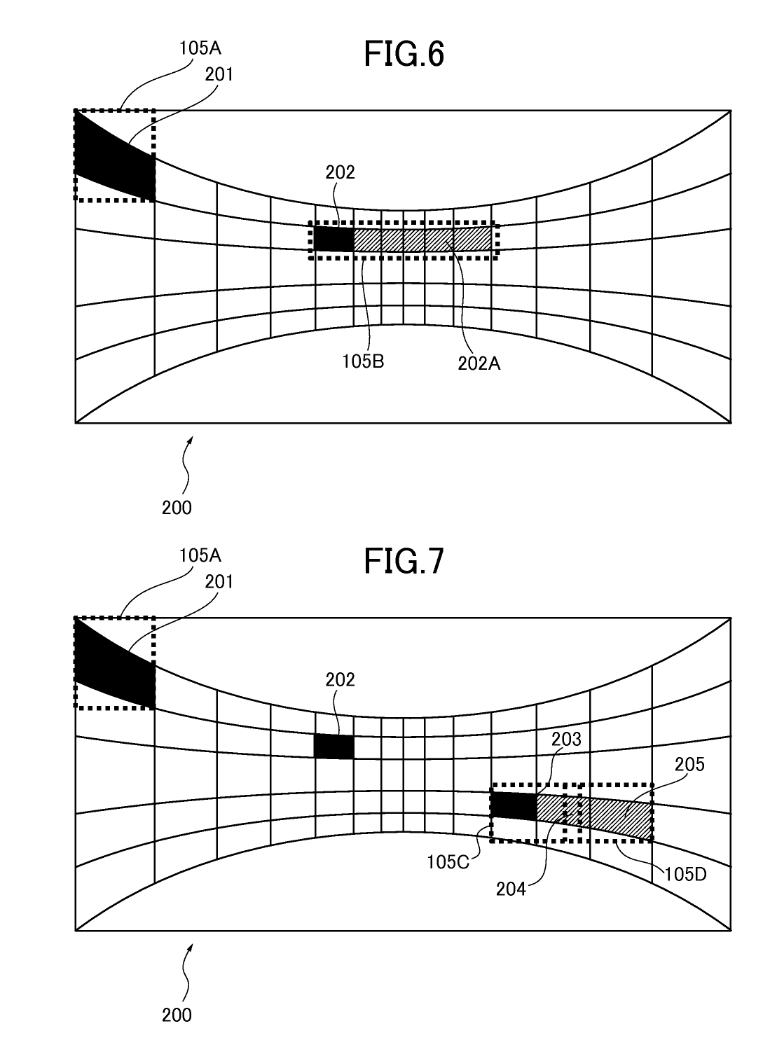

Here, the operation for retrieving the reference image data (steps S4 and S5) will be explained. FIGS. 4, 6 and 7 show an example of the operation, and FIG. 5 shows a state after the distortion correction is performed. In order to acquire the output image data of the area 301 shown in FIG. 5, the reference image data in the range 105A shown in FIG. 6, which is stored in the internal storage circuit 16 and includes the area 201 (that corresponds to the area 301), is required.

In order to acquire the output image of the area 302 shown in FIG. 5, at least the reference image data of the area 202 is required. Here, as mentioned above, the capacity of the internal storage circuit 16 is determined and fixed beforehand depending on the area with the largest capacity. On the other hand, the capacity of the reference image data differs depending on the areas. As illustrated by the dashed line 105B in FIG. 6, the capacity of the internal storage circuit 16 is larger than the capacity of the reference image data of the area 202, and still has more space to store another reference image data. Therefore, the determination circuit 20 continues retrieving (scanning) the reference image data from the external storage circuit 5 until the capacity of the retrieved (scanned) reference image data reaches to the capacity of the internal storage circuit 16. In Embodiment 1, as the scanning processing is carried out from the left to the right for each line from the upper line toward the lower line, the scanning processing is finished (terminated) when the reference image data of the areas 202A (illustrated by hatching) is retrieved from the external storage circuit 5, i.e., in total, the reference image data of six areas are retrieved from the external storage circuit 5.

It should be noted that although the ranges 105A, 105B, 105C and 105D are illustrated with rectangular dashed lines in FIGS. 6 and 7, these lines schematically show the data size that can be stored in the internal storage circuit 16 at one time just for convenience, i.e., the ranges are not factually divided in rectangular shapes.

However, although the processing becomes more complicated, it is of course possible to divide the ranges 105A, 105B, 105C and 105D in the same rectangular shapes and to retrieve the reference image data independently of the scanning direction.

Explanation of FIG. 1 is now resumed. After retrieving the reference image data from the external storage circuit 5, the image distortion circuit 10 corrects the distortion of the retrieved reference image data and outputs the result. To be specific, since the reference image data of plural (six) areas have been retrieved during the abovementioned scanning processing, the image distortion circuit 10 sequentially performs the correction processing to the retrieved reference image data and outputs the result for each area until the correction processing is performed for all areas (step S6: YES).

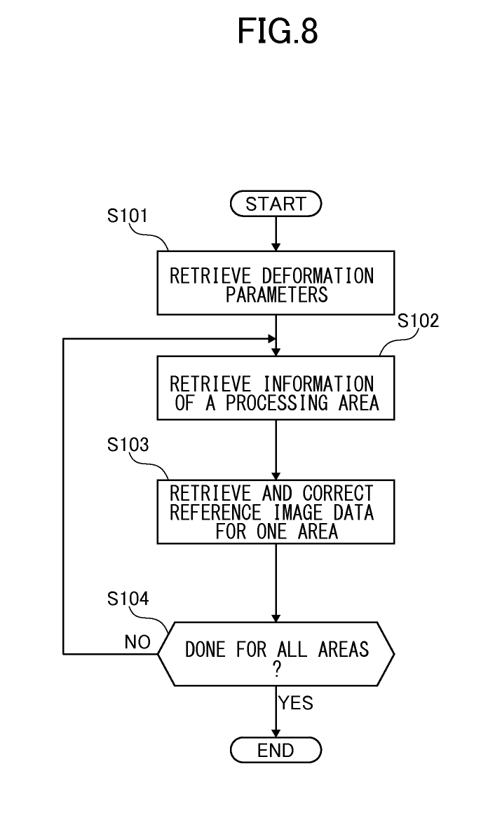

FIG. 8 is a flowchart showing the processing to retrieve the reference image data from the external storage circuit in a conventional technique. As shown in FIG. 8, the deformation parameters stored in the external storage circuit 5 are retrieved (step S101). Next, information about an area of the reference image data where the image deformation circuit 10 is about to perform the processing is retrieved (step S102).

The processing from the step S100 to the step S102 is the same as the processing performed in Embodiment 1. However, in the conventional technique, it retrieves the reference image data of only one area (step S103). Specifically, in the conventional technique, it only retrieves the reference image data of only one area during one scanning processing even if the internal storage circuit 16 has a capacity to store more image data. In contrast, Embodiment 1 of the present invention can retrieve the reference image data of plural areas in one scanning processing, thereby enabling to decrease the total number of scanning processing and to perform the entire processing efficiently.

### Embodiment 2

It is not necessary to retrieve the reference image data by an area. Therefore, in Embodiment 2, it is configured to divide the areas and their corresponding reference image data into more than one (i.e., divided into plural parts), and the determination circuit 20 is configured to retrieve the divided reference image data appropriately to performs the distortion correction.

Note that the remaining configurations and advantages remain the same as those of the first embodiment. Further, it is possible to apply the configurations of the second embodiment together with those of the first embodiment.

For example, as shown in FIG. 7, when retrieving the reference image data of the area 203 that is included in the range 105C of the internal storage circuit 16, the determination circuit 20 can retrieve the reference image data of not only the area 203 but also about 80% of the adjacent area 204 (because that is also included in the range 105C). Further, when retrieving the reference image data of the area 205 that is included in the range 105D, the determination circuit 20 can retrieve the reference image data of the area 205 and about 60% of the adjacent area 204.

In this case, the image distortion circuit 10 performs the distortion correction on the area 203 and the left half of the area 204 upon retrieving the first reference image data (i.e., the reference image data of the area 203 and 80% of the area 204). Further, the image distortion circuit 10 performs the correction on the right half of the area 204 and the area 205 upon retrieving the second reference image data (i.e., the reference image data for the area 205 and 60% of the area 204). In other words, the determination circuit 20 can corrects the distortion of three areas 203, 204, and 205 by retrieving the reference image data only two times. Note that how many of the reference image data to be retrieved from the external storage circuit 5 is determined by the determination circuit 20.

As explained above, in Embodiment 2, it is configured to divide the areas, and the determination circuit 20 is configured to retrieve the reference image data partially. With this, it becomes possible to reduce the number of performing the scanning processing and the correction processing, thereby improving the efficiency of the entire image processing.

### Embodiment 3

In Embodiment 3, it is configured to include a processing range predetermining unit to determine the processing range instead of the determination circuit 20. Specifically, it is configured such that the processing area predetermining unit stores a position and a direction of the scanning processing and a range to be processed into a table, etc. of the external storage circuit 5 in advance. Hence, if the deformation parameters are known, it is possible to calculate the optimal scanning range for each input image and to store the calculated result in the table, etc.

As mentioned above, in Embodiment 3, it does not have to calculate the scanning position, scanning direction, and so on for every scanning processing. Therefore, it becomes possible to improve the efficiency of the image processing even more.

Although the present invention has been described in terms of exemplary embodiments, it is not limited thereto. It should be appreciated that variations may be made in the embodiments described by persons skilled in the art without departing from the scope of the present invention as defined by the following claims.

Further, the distorted images shown in FIG. 4, etc. are only an example. It is of course possible to apply the embodiments of the invention for other distorted images, e.g., an image in which the distortion of the center is stronger, while the distortion of the outside (edge) is weaker.

Furthermore, it is possible to pre-install the abovementioned image processing program into an image processing apparatus, or an image distortion apparatus, or a computer-readable recording medium. Also, it is possible to install the program to a terminal connected to the image processing apparatus via the internet so as to control the image distortion apparatus.

What is claimed is:

1. An image processing apparatus comprising:
a scanning unit which scans a reference image data generated by dividing an input image data having distortion into plural areas;
a storage which stores the scanned image data;
a processing range determining unit which determines a range for the image data to be processed among the stored image data; and
a correcting unit which performs a distortion correction on the image data within the determined range,
wherein the processing range determining unit determines the range to be larger than the reference image data.

2. The apparatus according to claim 1, wherein the processing range determining unit determines the range to include a plurality of said reference image data.

3. The apparatus according to claim 1, wherein the reference image data is divided into plural parts, and
the processing range determining unit determines the range to include at least one of the divided part of the reference image data.

4. The apparatus according to claim 2, wherein the reference image data is divided into plural parts, and
the processing range determining unit determines the range to include at least one of the divided part of the reference image data.

5. The apparatus according to claim 1 further includes a processing range predetermining unit which calculates a position and the range to be scanned by the scanning unit based on the input image data prior to commencing the scanning by the scanning unit and stores the calculated results into a table,
wherein the processing range predetermining unit determines the range based on the calculated results stored in the table.

6. The apparatus according to claim 2 further includes a processing range predetermining unit which calculates a position and the range to be scanned by the scanning unit based on the input image data prior to commencing the scanning by the scanning unit and stores the calculated results into a table,
wherein the processing range predetermining unit determines the range based on the calculated results stored in the table.

7. The apparatus according to claim 3 further includes a processing range predetermining unit which calculates a position and the range to be scanned by the scanning unit based on the input image data prior to commencing the scanning by the scanning unit and stores the calculated results into a table,
wherein the processing range predetermining unit determines the range based on the calculated results stored in the table.

8. The apparatus according to claim 4 further includes a processing range predetermining unit which calculates a position and the range to be scanned by the scanning unit based on the input image data prior to commencing the scanning by the scanning unit and stores the calculated results into a table,
wherein the processing range predetermining unit determines the range based on the calculated results stored in the table.

9. An image processing method comprising:
a scanning step for scanning a reference image data generated by dividing an input image data having distortion into plural areas;
a processing range determining step for determining a range for the image data to be processed among the scanned image data; and
a correction step for correcting distortion of the image data within the determined range.

10. A computer-readable recording medium storing a program for causing a processor of an image processing apparatus to execute the method according to claim 9.
